(19) United States
(12) Patent Application Publication
(10) Pub. No.: US 2007/0211710 A1
(43) Pub. Date: Sep. 13, 2007

(54) Parameter sheet generating device, and corporeal computer program storage medium

(75) Inventors: Tomoya Hitokoto, Saitama (JP); Noriyuki Matsui, Saizuoka (JP); Kazutaka Oki, Saitama (JP)

Correspondence Address: VENABLE LLP, P.O. BOX 34385, WASHINGTON, DC, 20043-9998, US

(73) Assignee: Oki Electric Industry Co., Ltd., Tokyo (JP)

(21) Appl. No.: 11/713,601

(22) Filed: Mar. 5, 2007

(30) Foreign Application Priority Data
Mar. 7, 2006 (JP) 2006-061234

(51) Int. Cl. H04L 12/50

(52) U.S. Cl. 370/360

(57) ABSTRACT

A novel and improved parameter sheet generating device and computer program, which can automatically generate a parameter sheet from system configuration information of a computer system, are provided. The parameter sheet generating device includes: a receiving section that receives system configuration information, which structures the operating system managing the computer system, and in which the parameters for operating the operating system are described; an analyzing section analyzing contents of the received system configuration information, and acquiring the parameters described in the system configuration information; and a generating section recording the parameters acquired at the analyzing section in the parameter sheet, and generating the parameter sheet.

### CROSS-REFERENCE TO RELATED APPLICATION

This application claims priority under 35 USC 119 from Japanese Patent Application No. 2006-061234, the disclosure of which is incorporated by reference herein.

### BACKGROUND OF THE INVENTION

1. Field of the Invention

The present invention relates to a parameter sheet generating device and a corporeal storage medium storing a computer program for generating a parameter sheet.

2. Description of the Related Art

When configuring a computer system such as a server computer or a host computer, the system builder who is configuring the system configures an operating system (OS) which manages the computer system, and designs system configuration information in which parameters for operating the operating system are described. For example, the name of the computer, network setting values such as the IP (Internet Protocol) address and subnet mask, the default gateway, and the like, the values of the definition information (configuration) of the kernel, and the like which are needed for OS installation, are included in the system configuration information. Then, the system builder installs the OS in accordance with the designed system configuration information.

When installing an OS, the system builder notes the values of the designed system configuration information in a sheet prepared by word processing software or spreadsheet software or the like, and actually installs the OS by referring to this sheet. Hereinafter, the sheet in which the system builder notes the values of the system configuration information will be called a “parameter sheet”.

The system builder enters, in the parameter sheet, the computer name (host name), network setting values such as the IP address, subnet mask, the default gateway and the like, the values of the definition information (configuration) of the kernel, and the like which are needed for OS installation.

The entering of the values of the system configuration information in a parameter sheet is carried out in advance so that when a computer system is configured, the setting of incorrect parameters at the time of configuring the computer system can be prevented due to the system builder configuring the system by referring to the parameter sheet. Further, after the system is configured, by referring to the parameter sheet which was used at the time of configuring the system, it can be understood which settings the system was configured under.

FIG. 8 is an explanatory diagram explaining the configuration of a computer system. As shown in FIG. 8, before configuring the system, a system builder 10 enters the values of the system configuration information in a parameter sheet 11, and carries out configuration of a computer system 12 in accordance with the values of the system configuration information which are entered in the parameter sheet 11.

The system configuration information which is set can be acquired all at once by the method disclosed in Japanese Patent Application Laid-Open (JP-A) No. 2005-266919 for example. The system configuration information which is set at the computer system is made into files, and it amounts to several hundred of these files. If an abnormality arises at the system, the system configuration information is acquired, and by analyzing the acquired system configuration information, the cause of the abnormality can be ascertained, and by changing the settings of the system, the system can be recovered to normal.

Essentially, the system builder must configure the computer system after entering the system configuration information in the parameter sheet. However, there are cases in which a computer system is configured without the information being entered into a parameter sheet. In such cases, in order to refer to the parameters which are set at the configured computer system, the system configuration information set at the computer must be obtained by the method of JP-A No. 2005-266919.

However, even if the system configuration information is acquired, because the amount of the acquired system configuration information amounts to several hundred files, there is the problem that it is difficult to enter the values of the system configuration information into a parameter sheet from the acquired system configuration information.

Further, even in cases in which the system builder enters the values of the system configuration information in a parameter sheet at the time of configuring a computer system, as time passes, the system configuration information on the computer changes due to new software being installed into the computer system, the settings being changed, or the like. However, if changing of the parameter sheet is neglected, there are cases in which there is no longer correspondence between the system configuration information of the parameter sheet and the system configuration information of the actual computer.

In such cases, a parameter sheet in which the latest system configuration information is entered does not exist. Therefore, if, for example, a disk failure arises and the system must be reconstructed, there is the problem that the same system cannot be configured.

### SUMMARY OF THE INVENTION

The present invention is developed in light of such problems, and is to provide a novel and improved parameter sheet generating device and corporeal program storage medium which stores a computer program, which can automatically generate a parameter sheet from system configuration information of a computer system.

In order to address the above-described problems, in accordance with one aspect of the present invention, there is provided a parameter sheet generating device generating a parameter sheet which is for recording parameters which are set values of an operating system managing a computer system, and in which the set values are recorded in corresponding places, the device including: a receiving section that receives system configuration information, which configures the operating system managing the computer system, and in which the parameters for operating the operating system are described; an analyzing section analyzing contents of the received system configuration information, and acquiring the parameters described in the system configuration information; and a generating section recording the parameters acquired at the analyzing section in the parameter sheet, and generating the parameter sheet.

In accordance with this structure, the receiving section receives the system configuration information, the analyzing section analyzes the contents of the system configuration information and acquires the parameters corresponding to the items of the parameter sheet, and the generating section generates a parameter sheet on the basis of the parameters acquired by the analyzing section. As a result, in accordance with the parameter sheet generating device in accordance with the aspect of the present invention, a parameter sheet can be generated easily from a vast amount of system configuration information acquired from a computer system, and even a technician who is not well acquainted with the way of referring to the system configuration information can easily grasp the contents of the system configuration information.

The above-described parameter sheet generating device may further include a webpage displaying section displaying a webpage that can be accessed from an exterior via a web browser, wherein the system configuration information can be transmitted from the web browser via the webpage which the webpage displaying section displays. In accordance with this structure, the webpage displaying section displays a webpage at which system configuration information can be transmitted from a web browser. As a result, provided that there is an environment in which the webpage displayed by the webpage displaying section can be accessed, the system configuration information can be transmitted from that environment.

The analyzing section may analyze plural sets (types) of the system configuration information, and the generating section may generate the parameter sheet per set of system configuration information. In accordance with this structure, the parameter sheet generating device receives plural sets of system configuration information, and generates a parameter sheet for each set of the received system configuration information. As a result, plural sets of system configuration information can be received at one time, and, from these plural sets of system configuration information, a parameter sheet can be generated for each set of system structure information.

The generating section may further generate information relating to differences between the plural sets of system configuration information. In accordance with this structure, the generating section detects differences between the system configuration information, and generates information relating to the differences. As a result, the differences between the plural sets of system configuration information can be easily grasped.

The parameter sheet may be generated in the form of a spreadsheet. As a result, by generating the parameter sheet in the form of a spreadsheet, plural parameter sheets can be generated together in one file.

In order to address the above-described problems, in accordance with another aspect of the present invention, there is provided a corporeal program storage medium storing a computer program that generates a parameter sheet which is for recording parameters which are set values of an operating system managing a computer system, and in which the set values are recorded in corresponding places, the program causes a computer to execute processings including: receiving system configuration information, which structures the operating system managing the computer system, and in which parameters for operating the operating system are described; analyzing contents of the received system configuration information, and acquiring the parameters within the system configuration information; and recording, in the parameter sheet, the parameters acquired by analysis of the system configuration information, and generating the parameter sheet.

In accordance with this structure, the computer program causes the computer to receive the system configuration information, analyze the contents of the received system configuration information and acquire the parameters corresponding to the items of the parameter sheet, and generate a parameter sheet on the basis of the acquired parameters. As a result, in accordance with the computer program of this aspect of the present invention, a parameter sheet can be generated easily from a vast amount of system configuration information acquired from a computer system, and even a technician who is not well acquainted with the way of referring to the system configuration information can easily grasp the contents of the system configuration information.

The processing of generating the parameter sheet may include analyzing plural sets of the system configuration information, and generating the parameter sheet per set of system configuration information. In accordance with this structure, the computer program causes the computer to receive plural sets of system configuration information, and generate a parameter sheet for each set of the received system configuration information. As a result, plural sets of system configuration information can be received at one time, and, from these plural sets of system configuration information, a parameter sheet can be generated for each set of system configuration information.

The processing may further including generating information relating to differences between the sets of system configuration information. In accordance with this structure, the computer program causes the computer to detect differences between the system configuration information, and generate information relating to the differences. As a result, the differences between the plural sets of system configuration information can be easily grasped.

The parameter sheet may be generated in the form of a spreadsheet. As a result, by generating the parameter sheet in the form of a spreadsheet, plural parameter sheets can be generated together in one file.

As described above, in accordance with the present invention, a parameter sheet generating device and a storage medium storing a computer program for generating a parameter sheet can be provided.

### BRIEF DESCRIPTION OF THE DRAWINGS

Preferred exemplary embodiments of the present invention will be described in detail based on the following figures, wherein:

FIG. 1 is an explanatory diagram showing a system which includes a parameter sheet generating device relating to a first exemplary embodiment of the present invention;

FIG. 2 is an explanatory diagram explaining the parameter sheet generating device of the first exemplary embodiment of the present invention;

FIG. 3 is an explanatory diagram explaining a parameter sheet in the first exemplary embodiment of the present invention;

FIGS. 4A and 4B are an explanatory diagrams explaining system configuration information in the first exemplary embodiment of the present invention;

FIG. 5 is a flowchart explaining a parameter sheet generating method in the first exemplary embodiment of the present invention;

FIG. 6 is an explanatory diagram showing a system which includes a parameter sheet generating device relating to a second exemplary embodiment of the present invention;

FIG. 7 is a flowchart explaining a parameter sheet generating method in the second exemplary embodiment of the present invention; and

FIG. 8 is an explanatory diagram showing a summary of a conventional computer system configuration method.

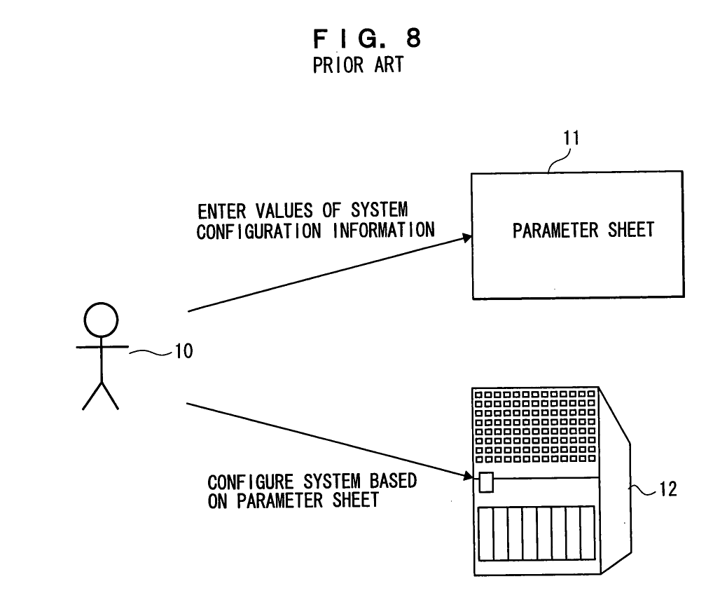

### DETAILED DESCRIPTION OF THE INVENTION

Preferred exemplary embodiments of the present invention will be described in detail hereinafter with reference to the appended drawings. Note that, in the present specification and drawings, redundant description is omitted by denoting structural elements, which have substantially the same functions and structures, by the same reference numerals.

### First Exemplary Embodiment

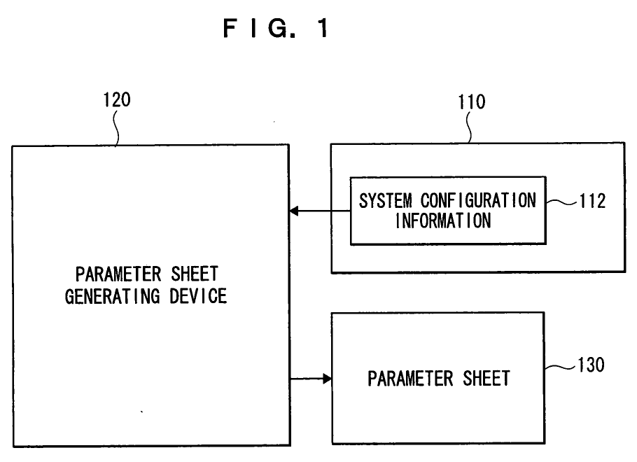

FIG. 1 is an explanatory diagram showing a system which includes a parameter sheet generating device relating to a first exemplary embodiment of the present invention. At a parameter sheet generating device 120 relating to the first exemplary embodiment of the present invention, system configuration information 112 of a computer system 110 is received, the received system configuration information 112 is analyzed, and a parameter sheet 130 is generated.

The computer system 110 is, for example, a server computer or a host computer. Installation of an OS, setting of the computer name after the OS installation, setting of the network such as the IP address and the subnet mask, the default gateway, and the like, settings of the kernel, and the like may be carried out to the computer system 110 by the system builder who constructs the computer system.

When the parameter sheet generating device 120 is to generate the parameter sheet 130, the parameter sheet generating device 120 receives system configuration information from the computer system 110. The system configuration information is transmitted to the parameter sheet generating device 120 in a form in which plural files are collected. The system configuration information may be transmitted from the computer system 110 to the parameter sheet generating device 120 by File Transfer Protocol (FTP), or may be transmitted by HTTP (HyperText Transfer Protocol).

The parameter sheet generating device 120 analyzes the system configuration information transmitted from the computer system 110 to the parameter sheet generating device 120, and acquires the parameters included in the system configuration information. Then, the parameter sheet generating device 120 enters the parameters acquired from the system configuration information in predetermined places (fields) of the parameter sheet 130, and outputs the parameter sheet 130 in which the parameters are entered.

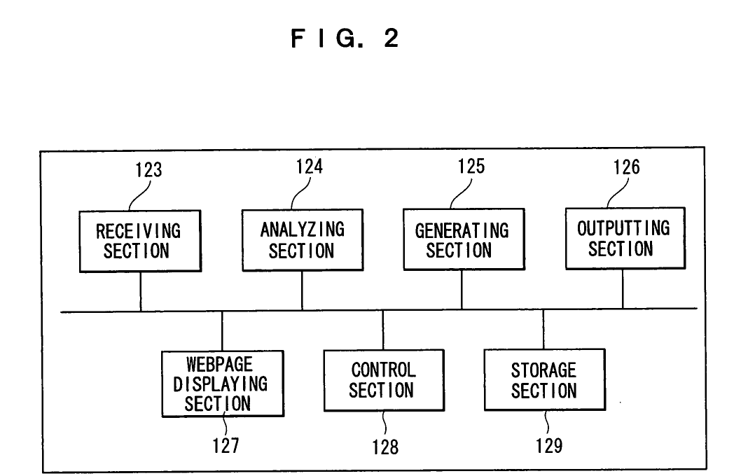

The system which includes the parameter sheet generating device relating to the first exemplary embodiment of the present invention has been described above by using FIG. 1. Next, the parameter sheet generating device relating to the first exemplary embodiment of the present invention will be described by using FIG. 2.

FIG. 2 is an explanatory diagram explaining the parameter sheet generating device relating to the first exemplary embodiment of the present invention. As shown in FIG. 2, the parameter sheet generating device 120 relating to the first exemplary embodiment of the present invention is structured to include a receiving section 123, an analyzing section 124, a generating section 125, an outputting section 126, a webpage displaying section 127, a control section 128, and a storage section 129.

The receiving section 123 receives the system configuration information which is information of the operating system structuring the computer system. The system configuration information may be directly transmitted from the computer system 110 as in FIG. 1, or the system configuration information may be stored once in a separate terminal (a personal computer or the like) and transmitted from that terminal.

The analyzing section 124 carries out analysis of the system configuration information received at the receiving section 123, and acquires the parameters which are described in the system configuration information. On the basis of the results of the analysis of the system configuration information at the analyzing section 124, the generating section 125 enters the values of the parameters acquired at the analyzing section 124 into corresponding places (fields) of the parameter sheet, and generates the parameter sheet. The outputting section 126 outputs the parameter sheet which is generated at the generating section 125.

The webpage displaying section 127 displays a webpage which can be accessed from the exterior via a web browser. The displayed webpage is created such that the transmission of files is possible. At the parameter sheet generating device 120, the system configuration information may be transmitted via the webpage displayed at the webpage displaying section 127.

The control section 128 controls the operations of the respective sections of the parameter sheet generating device 120. The control section 128 is structured from, for example, a CPU, a RAM (Random Access Memory), a ROM (Read Only Memory), and the like.

The storage section 129 stores various types of information of the parameter sheet generating device 120, and is structured by a hard disk drive for example. The storage section 129 may store computer programs which, in accordance with calls from the control section 128, execute processings which control the receiving section 123, the analyzing section 124, the generating section 125, the outputting section 126, and the webpage displaying section 127.

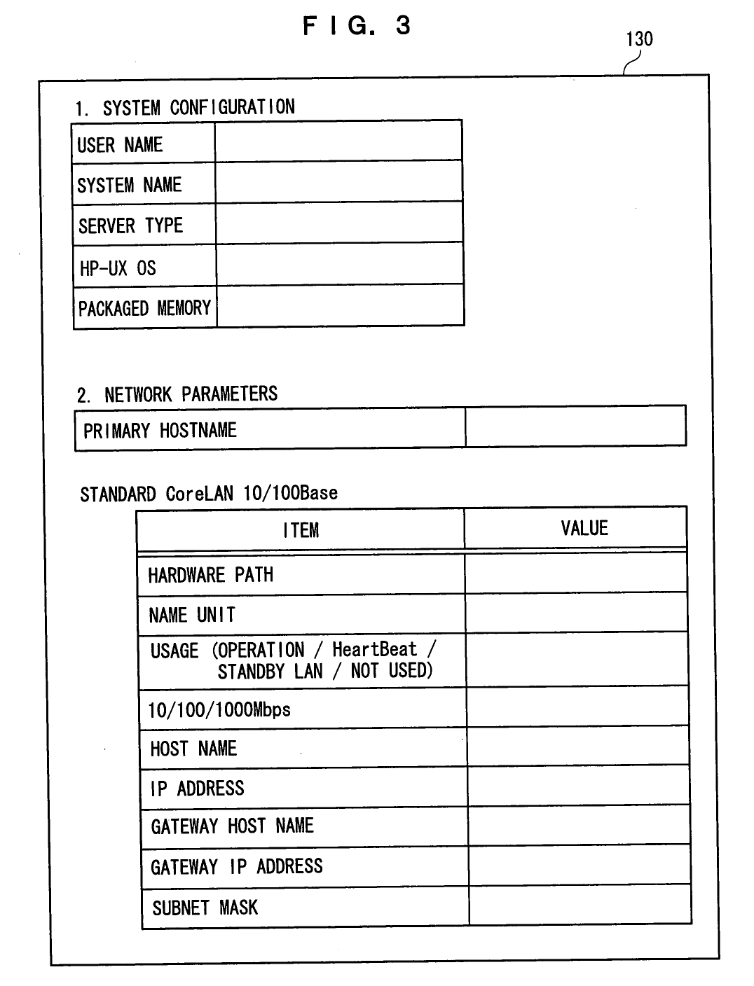

The parameter sheet generating device relating to the first exemplary embodiment of the present invention has been described above by using FIG. 2. Next, the parameter sheet relating to the first exemplary embodiment of the present invention will be described by using FIG. 3.

FIG. 3 is an explanatory diagram explaining a parameter sheet relating to the first exemplary embodiment of the present invention. When configuring a computer system, the parameter sheet 130 such as shown in FIG. 3 is readied, and the system builder enters, in the parameter sheet, the parameters which are set at the time of configuring the computer system.

The parameter sheet may be generated in the form of a table in which data is structured in rows and columns. As an example of a table in which data is structured in rows and columns, the table may be generated in the form of a spreadsheet. Further, the parameters may be directly entered, or may be selected from among values which are set in advance.

In the parameter sheet 130 such as shown in FIG. 3, the parameter sheet is completed by the system builder entering or selecting values for the items of “User Name”, “System Name”, “Server Type”, “HP-UX OS”, “Packaged Memory” in the field “1. System Configuration”, and for the fields of “Primary Hostname” and “Values” of the “Standard CoreLAN 10/100Base” in “2. Network Parameters”. At the time when the system builder configures the computer system, he/she configures the computer system while looking at the parameter sheet in which the values have been entered.

Note that FIG. 3 is only a portion of the parameter sheet 130, and fields in which values are to be entered may be provided for, in addition to the network setting information, the setting information of the file system and the setting information of the parameters of the kernel. The values for these setting information as well can be entered or selected.

The parameter sheet by be created in the form of a spreadsheet by using spreadsheet software. In the case of creating the parameter sheet in the form of a spreadsheet, plural sheets can be generated at one file. Therefore, the parameter sheet can be made to be easy-to-use by changing the sheets in accordance with the type of the system configuration information, or the like.

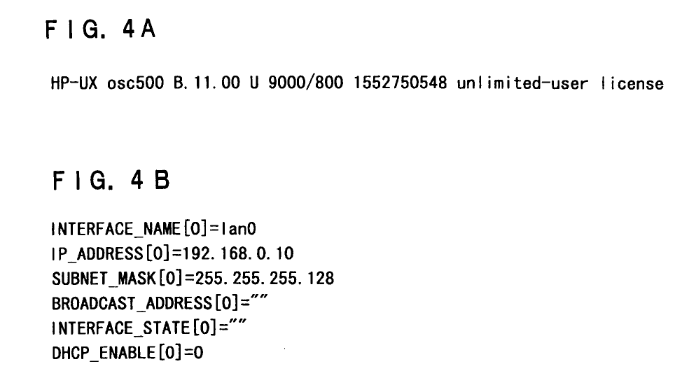

The parameter sheet relating to the first exemplary embodiment of the present invention has been described above by using FIG. 3. Next, the system configuration information relating to the first exemplary embodiment of the present invention will be described by using FIGS. 4A and 4B.

FIGS. 4A and 4B are an explanatory diagrams explaining the system configuration information relating to the first exemplary embodiment of the present invention. FIG. 4A shows information relating to the host name and the OS version number, and FIG. 4B shows, among the system configuration information, the information relating to the network.

In FIG. 4A, “osc500” which is the host name is entered in the second column, and “B.11.00” which is the version number of the OS is entered in the third column.

In FIG. 4B, “192.168.0.10” is entered in the “IP_ADDRESS[0]” field, which shows that the IP address of the computer having this system configuration information is “192.168.0.10”. Further, “255.255.255.128” is entered in the “SUBNET_MASK[0]” field, which shows that the subnet mask of the computer having this system configuration information is “255.255.255.128”.

Note that the system configuration information is not limited to these, and, in addition, information relating to the disk structure, the definition information (configuration) of the kernel, and the like may be described. The number of the files structuring the system configuration information may be amount to several hundred.

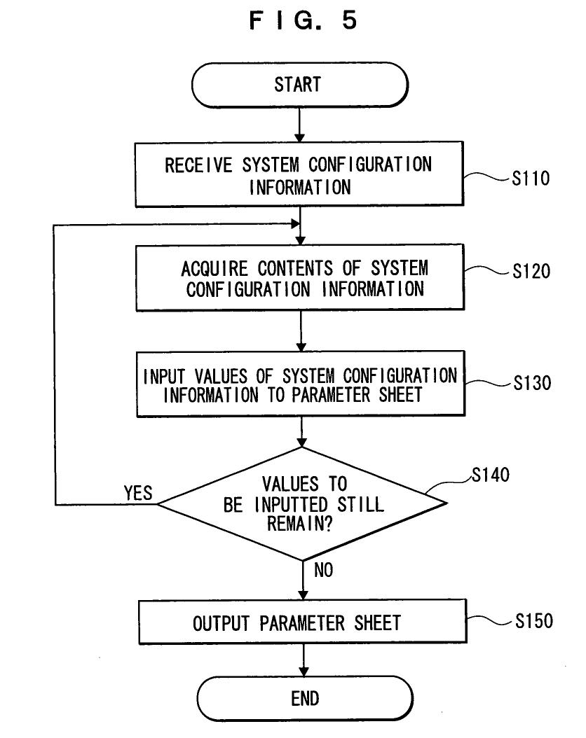

The system configuration information relating to the first exemplary embodiment of the present invention has been described above by using FIGS. 4A and 4B. Next, the parameter sheet generating method relating to the first exemplary embodiment of the present invention will be described by using FIG. 5.

FIG. 5 is a flowchart explaining a parameter sheet generating method relating to the first exemplary embodiment of the present invention. To explain the parameter sheet generating method relating to the first exemplary embodiment of the present invention by using FIG. 5, first, the receiving section 123 of the parameter sheet generating device 120 receives the system configuration information 112 acquired from the computer system 110 (step S110). As the method of acquiring the system configuration information 112 from the computer system, collective acquisition may be carried out by using the method of JP-A No. 2005-266919.

When the system configuration information is received, next, the analyzing section 124 analyzes the contents of the files of the system configuration information, and acquires the contents of the system configuration information (step S120). When the contents of the system configuration information are acquired, the generating section 125 enters the values, which are acquired by the analyzing section 124, into the corresponding places (fields) in the parameter sheet 130 (step S130).

For example, in the case of the parameter sheet 130 as shown in FIG. 3, if, as the result of acquiring the contents of the system configuration information, there is an item corresponding to “Packaged Memory” in the “1. System Configuration” field of the parameter sheet 130, the value of the packaged memory described in the system configuration information is entered in the “Packaged Memory” field of the parameter sheet 130.

Further, in a case in which the system configuration information as shown in FIGS. 4A and 4B is received, the information of the host name, the OS version number, the IP address, and the subnet mask is entered. Therefore, the value “osc500” is entered in the host name field of the parameter sheet 130, the value “B.11.00” is entered in the OS version number field, the value “192.168.0.10” is entered in the IP address field, and the value “255.255.255.128” is entered in the subnet mask field.

Then, it is confirmed whether or not any fields in which information is to be entered still remain in the parameter sheet 130 (step S140). If fields in which information is to be entered still remain, the routine returns to above step S120, and again, the analyzing section 124 acquires the contents of the system configuration information and the generating section 125 enters the values acquired at the analyzing section 124 into the parameter sheet 130. On the other hand, if there are no remaining fields in which information is to be entered in the parameter sheet 130, the outputting section 126 outputs the parameter sheet 130 (step S140), and the processing is completed.

The parameter sheet generating method relating to the first exemplary embodiment of the present invention has been described above by using FIG. 5.

As described above, in accordance with the parameter sheet generating device relating to the first exemplary embodiment of the present invention, even if, after a computer system is configured, the values of the parameters at the time of configuration become unknown, or the settings of the computer system are changed and there is no longer correspondence between the values of the parameter sheet and the values of the computer system, even a technician who does not know the way of referring to the system configuration information set at the computer system can automatically generate the latest parameter sheet from the system configuration information.

### Second Exemplary Embodiment

The first exemplary embodiment describes a parameter sheet generating device which automatically generates the latest parameter sheet from the system configuration information set at the computer system. In the second exemplary embodiment, description will be given of a parameter sheet generating device in which, at a time when the settings of the computer system are changed, the system configuration information before the change in setting and the system configuration information after the change in setting are transmitted, and a parameter sheet is generated from both the system configuration information before the change in setting and the system configuration information after the change in setting.

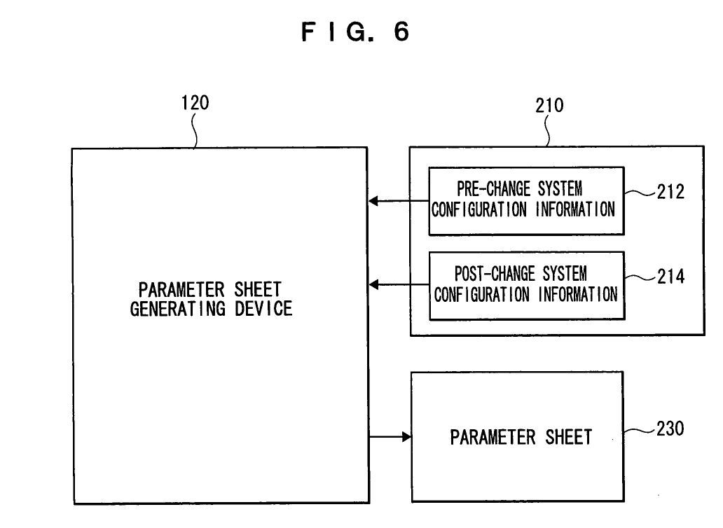

FIG. 6 is an explanatory diagram showing a system which includes a parameter sheet generating device relating to a second exemplary embodiment of the present invention. In the parameter sheet generating device 120 relating to the second exemplary embodiment of the present invention, pre-change system configuration information 212 and post-change system configuration information 214 are received from a computer system 210, the received pre-change system configuration information 212 and post-change system configuration information 214 are analyzed, and a parameter sheet 230 is generated.

In the present exemplary embodiment, the parameter sheet generating device 120 receives two sets of system configuration information which are the pre-change and post-change system configuration information, and generates the parameter sheet 230. However, the present invention is not limited to the same, and the parameter sheet 230 may be generated by receiving three or more sets of system configuration information.

At the computer system 210, the installation of the OS, the setting of the computer name, the IP address and the kernel after OS installation, and the like may be carried out by an overseer who constructs the computer system.

At the time of generating the parameter sheet 230, the parameter sheet generating device 120 receives system configuration information from the computer system 210. In the present exemplary embodiment, the two sets of system configuration information, which are the pre-change system configuration information 212 and the post-change system configuration information 214, are received.

Both of these system configuration information are transmitted to the parameter sheet generating device 120 in a form in which a plurality of files are collected. The system configuration information may be transmitted from the computer system 210 to the parameter sheet generating device 120 by FTP, or may be transmitted from the computer system 210 to the parameter sheet generating device 120 by HTTP.

The parameter sheet generating device 120 analyzes the pre-change system configuration information 212 and the post-change system configuration information 214 transmitted from the computer system 210 to the parameter sheet generating device 120, and enters the values acquired from the system configuration information into predetermined fields of the parameter sheet 230. Then, the parameter sheet generating device 120 outputs the parameter sheet 230 in which the values are entered.

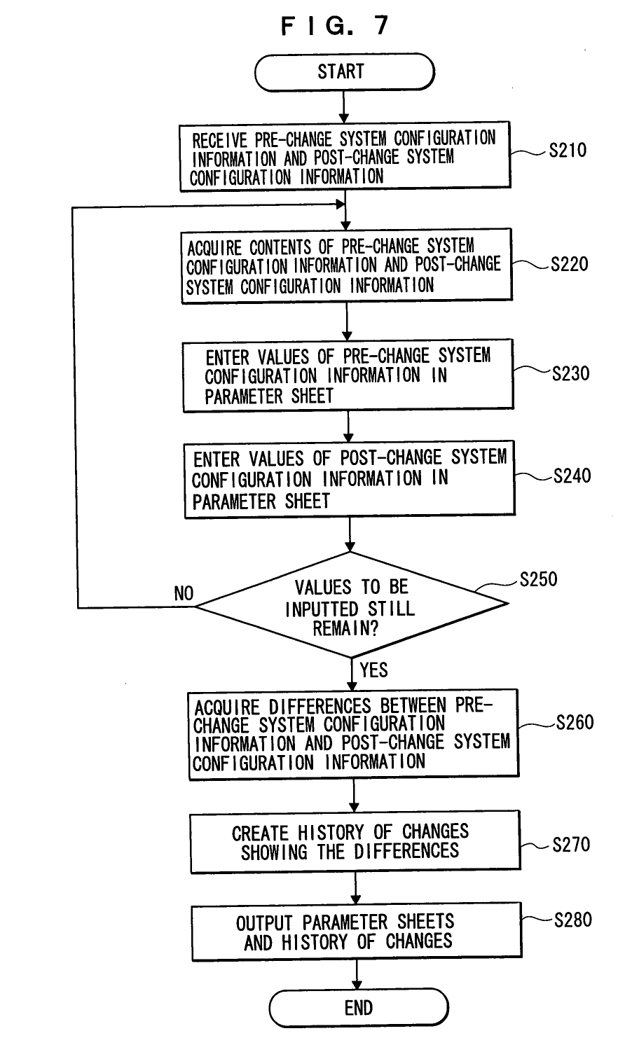

A system which includes the parameter sheet generating device relating to the second exemplary embodiment of the present invention is described above by using FIG. 6. Because the structure of the parameter sheet generating device relating to the second exemplary embodiment of the present invention is the same as that of the first exemplary embodiment, detailed description thereof is omitted. Next, a parameter sheet generating method relating to the second exemplary embodiment of the present invention will be described by using FIG. 7.

FIG. 7 is a flowchart explaining the parameter sheet generating method relating to the second exemplary embodiment of the present invention. To explain the parameter sheet generating method relating to the second exemplary embodiment of the present invention by using FIG. 7, first, the parameter sheet generating device 120 receives the pre-change system configuration information 212 and the post-change system configuration information 214 acquired from the computer system 210 (step S210). In the present exemplary embodiment as well, as the method of acquiring the pre-change system configuration information 212 and the post-change system configuration information 214 from the computer system, collective acquisition may be carried out by using the method of JP-A No. 2005-266919.

When the system configuration information is received, next, the analyzing section 124 analyzes the contents of the files of the pre-change system configuration information 212 and the post-change system configuration information 214, and acquires the contents of the system configuration information (step S220). When the contents of the system configuration information are acquired, the generating section 125 enters the values of the pre-change system configuration information 212, which were acquired by the analyzing section 124, into the corresponding fields in the parameter sheet 230 (step S230). Then, the generating section 125 enters the values of the post-change system configuration information 214 into the corresponding fields of the parameter sheet 230 (step S240).

The values of the pre-change system configuration information 212 and the values of the post-change system configuration information 214 are entered in separate parameter sheets respectively. By entering these information into separate parameter sheets, the contents of the settings of each system configuration information can be grasped easily.

Then, it is confirmed whether or not any fields in which information is to be entered still remain in the parameter sheets 230 (step S250). If places in which information is to be entered still remain, the routine returns to above step S220, and again, the analyzing section 124 acquires the contents of the system configuration information and the generating section 125 enters the values acquired at the analyzing section 124 into the parameter sheets 230. On the other hand, if there are no remaining fields in which information is to be entered in the parameter sheets 230, the analyzing section 124 acquires the items at which there is a difference between the value of the pre-change system configuration information 212 and the value of the post-change system configuration information 214 (step S260).

The differences between the values of the pre-change system configuration information 212 and the values of the post-change system configuration information 214, which the analyzing section 124 acquires, are collected together and generated as a history of changes (step S270), separately from the parameter sheets in which the values were entered in above-described step S240. By gathering together these differences separately, the points which have changed in the contents of the settings of the respective system configuration information can easily be grasped.

The outputting section 126 outputs (step S280) the parameter sheets in which the values of the system configuration information were entered in above step S240 and the history of changes generated in above step S270, and the processing is completed.

The parameter sheet generating method relating to the second exemplary embodiment of the present invention has been described above by using FIG. 7.

As described above, in accordance with the parameter sheet generating device and parameter sheet generating method relating to the second exemplary embodiment of the present invention, at the time of changing the settings of a computer system, the system configuration information before the change in setting and the system configuration information after the change in setting are transmitted, and parameter sheets can be generated from both of the system configuration information before the change in setting and the system configuration information after the change in setting.

Preferred exemplary embodiments of the present invention have been described above with reference to the appended drawings, but the present invention is not to be limited to these examples. It will be apparent to those skilled in the art that various modified examples and revised examples are possible within the scope of the claims, and these as well are to, of course, be understood as belonging within the technical scope of the present invention.

What is claimed is:

1. A parameter sheet generating device generating a parameter sheet, which is for recording parameters which are set values of an operating system managing a computer system, and in which the set values are recorded in corresponding places, the device comprising:
a receiving section that receives system configuration information which configures the operating system managing the computer system, and in which the parameters for operating the operating system are described;
an analyzing section analyzing contents of the received system configuration information, and acquiring the parameters described in the system configuration information; and
a generating section recording the parameters acquired at the analyzing section in the parameter sheet, and generating the parameter sheet.

2. The parameter sheet generating device of claim 1, further comprising:
a webpage displaying section displaying a webpage that can be accessed from an exterior via a web browser,
wherein the system configuration information can be transmitted from the web browser via the webpage which the webpage displaying section displays.

3. The parameter sheet generating device of claim 1, wherein
the analyzing section analyzes a plurality of sets of the system configuration information, and
the generating section generates the parameter sheet per set of system configuration information.

4. The parameter sheet generating device of claim 3, wherein the generating section further generates information relating to differences between the sets of system configuration information.

5. The parameter sheet generating device of claim 1, wherein the parameter sheet is generated in the form of a spreadsheet.

6. A corporeal program storage medium storing a computer program that generates a parameter sheet, which is for recording parameters which are set values of an operating system managing a computer system, and in which the set values are recorded in corresponding places, the program causes a computer to execute processings comprising:
receiving system configuration information which configures the operating system managing the computer system, and in which parameters for operating the operating system are described;
analyzing contents of the received system configuration information, and acquiring the parameters within the system configuration information; and
recording, in the parameter sheet, the parameters acquired by analysis of the system configuration information, and generating the parameter sheet.

7. The corporeal program storage medium of claim 6, wherein the generating of the parameter sheet comprises analyzing a plurality of sets of the system configuration information, and generating the parameter sheet per set of system configuration information.

8. The corporeal program storage medium of claim 7, wherein information relating to differences between the sets of system configuration information is further generated.

9. The corporeal program storage medium of claim 6, wherein the parameter sheet is generated in the form of a spreadsheet.
